(19) United States
(12) Patent Application Publication
(10) Pub. No.: US 2009/0113946 A1
(43) Pub. Date: May 7, 2009

(54) Anti-theft locking device with a flexible cable

(76) Inventor: Bret Baumgarten, Oakland, CA (US)

Correspondence Address: Bret Baumgarten, 373 - 4th Street # 1B, Oakland, CA, 94607, US

(21) Appl. No.: 11/982,682

(22) Filed: Nov. 5, 2007

(51) Int. Cl. E05B 73/00

(52) U.S. Cl. 70/18

(57) ABSTRACT

An anti-theft bicycle locking device that consists of a cylindrical housing rotatingly supporting a drum and having a semi-rigid cable which is retracted within a housing by a drum as S-shaped turns formed by a cranking mechanism of the drum consisting of two cylindrical hubs with an opening between them through which the cable is threaded when it is passed through the anti-theft locking device. When the drum is rotated by means of handle portions of the drum exposed through the housing, one exposed end of the cable is retracted onto one side of the drum and the other to the opposite side of the drum. The space between the inner surface of the housing and the outer surface of the drum and the direction of the outlet openings of the housing provide placement of the turns side by side on the drum surface.

### BACKGROUND

1. Field of Invention

This invention relates to an anti-theft locking device with a flexible cable, in particular to a bicycle anti-theft locking device with a storage unit for an excess portion of the length of a cable which is not in use.

2. Description of Prior Art

Bicycle theft is a common problem recognized internationally. To overcome these criminal acts, bicycle locks were developed to increase bicycle security. Originally, bicycle locks were heavy, cumbersome, and dangerous to both the bicycle and the consumer. Consequently, bicycle locks evolved to become more compact, efficient, and safe. The bicycle locks on the market today are represented by three basic varieties that involve a cable: 1) a “U-lock”, 2) a straight cable with a lock, and 3) a coiled cable with a lock.

Existing cables with locks are still relatively cumbersome, inconvenient, and potentially dangerous to apply and store. There is a tendency for a coiled cable to spring back and injure the consumer and/or damage the bicycle, while a straight cable is often wrapped around the handle bars or other portion of the frame to avoid dragging or entanglement with the wheels. A “U-lock” is limited in application because of its small size, for instance it can not efficiently secure a bicycle frame and wheels to a tree or post in many cases.

Thereafter, inventors have tried to eliminate the hazards and inefficiencies of both the straight and coiled cable locks by creating several types of cable security systems specifically for bicycles. Examples of these attempts are as follows: U.S. Pat. Nos. 3,990,279 (Nov. 9, 1976); 4,037,441 (Jul. 26, 1977); 4,044,577 (Aug. 30, 1977); 4,126,024 (Nov. 21, 1978); and 4,970,882 (Nov. 20, 1990) all utilize either one or two retractable spools with tension springs which while potentially expedient can cause physical harm to the bicycle and the consumer upon operation. In addition, all of the patents mentioned above, with the exception of U.S. Pat. No. 4,126,024, have the cable end attached directly to the internal structure of the casing leaving only one end of the cable to be unwound which can increase the time and effort of application. Similarly, U.S. Pat. No. 3,990,279 reveals anchoring the middle of the cable onto the internal spool on which it is to be wound which limits the usable length of the cable. U.S. Pat. No. 4,970,882 utilizes two independently rotatable spools with two individual cables that are both wound upon their respective spools which increases the complexity and minimizes the security of the system.

Because of the inherent physical properties of a semi-rigid steel cable or wire rope, all of the above patents would require a significant amount of both force and tension to wrap a cable onto and around an internal spool, and thus the same significant force must be exerted to release a wound cable. In addition to the disadvantages of the application and storage of the systems, there are a large number of moving parts that only add to the complexity of manufacturing and expense for the consumer.

Other materials such as rope, electrical cord, wire, and clothes lines have been stored in a portable fashion. The following patents utilize a similar technology to store the much more flexible material by wrapping and winding it onto and around its internal spool: U.S. Pat. Nos. 4,907,938 (Feb. 20, 1990); 3,782,654 (Jan. 1, 1974); 3,809,331 (May 7, 1974); 3,529,786 (September 1970); 2,952,420; 2,429,675 (October 1947); 1,186,131 (June 1910).

As mentioned previously, because of the physical properties required for a sufficient security device, all of the patents that wind the more flexible material onto and around a spool would not perform without problematic usage. Consequently, the patents and designs for the more flexible material systems are mechanically and physically inadequate to accommodate the required specifications of a semi-rigid cable security system.

### OBJECTS AND SUMMARY OF THE INVENTION

It is therefore a primary object of the present invention to provide a bicycle anti-theft cable locking device which is simple in construction, easy to manufacture, involves a minimum of different parts, is composed of durable easily and inexpensively manufactured molded plastic parts, can be easily operated by a left- and right-handed person, is provided with a cable storage unit for storing the unused portion of the cable during the use or for storing the entire cable during storage of the device, eliminates the dangerous tension and retractable operation and internal part complexity revealed in the prior art, and can be secured without damage to the bicycle or injure to the user.

The anti-theft cable locking device of the invention is particularly suited for securing a bicycle. The device contains a continuous semi-rigid cable or wire rope, the opposite ends of which are provided with loops, or mutually engageable and interlocking elements, such as, e.g., an insertable deadbolt and a dial-type cylinder that locks and releases the deadbolt only when a certain combination of numbers is aligned on the composite dial cylinder. The semi-rigid cable is passed through diametrically opposite openings of a substantially cylindrical outer housing of a cable storage unit that consists of two symmetrical molded parts connected to each other face-to-face and locked by means of snapping projection on one part that interacts with a respective recess on the other part.

Located inside the cylindrical housing is a rotary cable-driving drum which, in turn, is composed of two symmetrical cylindrical parts having on their outer sides handles for rotation of the drum in the direction of retracting the cable into the interior of the housing while the other sides of the symmetric cylindrical parts are connected and locked to each other in butt connection though engagement of projections and recesses. These projections and recesses are formed on pairs of diametrically arranged hubs formed on the facing sides of the aforementioned symmetric cylindrical parts.

As has been mentioned above, the hubs, which are monolithically molded with the rest of the body of the respective cable-driving drum parts, have a space formed between the nearest points thereof. The outer surfaces of the drum parts have a siding fit in respective openings formed in the end faces of the housing parts. Furthermore, the hubs project beyond the mating end faces of the respective symmetric cylindrical parts so that when the mating hubs of the opposite cylindrical parts are connected to each other through the interaction of their projections and recesses, the aforementioned space is formed. This space and the distance between the outer diameter of the drum and the inner surface of the housing parts are sufficient for guiding within, and threading the wire cable through the locking device of the invention.

On its outer surfaces the aforementioned symmetrical molded housing parts have radially projecting portions which in the assembled state of the housing are aligned and form a radial projection suitable for connection of the anti-theft locking device to a frame element of the bicycle.

During assembly, the two cylindrical parts of the rotating cable drum are assembled with each other by inserting the projections on the end faces of the hubs of one part of the drum into respective recesses on the facing end faces of the hubs on the opposite part of the drum. During assembly of the cylindrical parts of the rotating cable drum the central part of the wire cable, which in this case is straight, is placed into the opening formed between the hubs and is loosely sandwiched between both cylindrical hubs. In an assembled state with the wire cable between the cylindrical parts, these parts are nested in the respective symmetrical cylindrical parts of the cylindrical housing which are snapped together so that the drum and wire cable remains intact, the handle portions of the drum are exposed on both sides of the cylindrical housing, and the drum can freely rotate inside the cylindrical housing, while the opposite portions of the wire cable extend outward from the assembled device and can be used for their securing purpose. The cable ends are fabricated in a male/female combination in the form of mutually lockable elements. In order to retract the cable into the cylindrical housing, the handles are manually rotated in either clock-wise or counter clock-wise direction to take in the entire length of the cable into the housing leaving just the lockable cable ends outside of the housing.

It should be noted, however, that no end of the cable is positively secured to the rotating cable drum or to the housing. This intentional feature enables the users when cable is completely withdrawn, to pull one end of the cable through the rotating cable drum until the opposite cable end is adjacent to the exterior surface of the device housing. Furthermore, the outer surface of the cable does not wind onto the rotating cable drum. Therefore, rotation of the drum opposite the retracted direction will not extend the cable out from the locking device. The cable sections can be pulled out from the locking device only by applying the manual equal pulling force to both cable ends in opposite outward directions from the device housing. However, the projecting ends of the cable can be retracted back into the housing of the device by rotating the handle portion of the rotating cable drum in the retracting direction, or if the entire length of the cable is exposed, the cable can be retracted by rotating the handle in either a clock or counter clock-wise direction.

More specifically, when the drum is rotated with the cable passing through the openings of the drum and housing and between the hubs, e.g., in the form of a straight line, the cranking action of the hubs deforms the cable first in the form of letter “S” (for a viewer from the handle side of the drum) and then continues retracting of the cable in the form of a plurality of “S”-shaped turns arranged side by side parallel to each other on the drum by being guided by the inner surface of the outer casing and the diametrically opposed openings in the housing while contained by the interior surface of the housing. The space between the rotating cable drum and interior housing surface prevents the cable from retracting on a prior turn(s), and moves the prior retracted cable to the center of the rotating cable drum to allow the cable to continue to manually be retracted into the housing.

The aforementioned outward radial projection formed on the outer surface of the cylindrical housing can be connected to an adapter of a holding structure used for securing the locking device of the invention to the bicycle. The holding structure can be made, e.g., in the form of a coupling mechanism for coupling with the lock and a flexible strap with ratchet-like teeth. The coupling structure has a latch section latching in the wedge trough with two extendable button extended from two sides to insert into apertures formed on two sides of the wedge trough so that the coupling structure and the holding structure form a firm coupling. The adapter can be provided with an unlocking mechanism with a push button for activation of the unlocking mechanism. The device for attachment to the bicycle can be embodied in many other ways.

In use, the ends of the cable are fashioned into loops or other configurations which are of a size to maintain it outside of the housing. The cable is manually dispensed to its desired length so as to completely run through the bicycle frame, both wheels, around a stationary object, or the like, and the ends of the cable are locked together by means of the locking elements on the opposite ends of the wire cable. The extended length of the wire cable is then retracted into the housing by rotating the externally exposed handle(s) of the rotating cable drum.

To unsecure the bicycle, the user unlocks the lock that secures the ends of the wire cable, releases the cable from the stationary element, such as a post, fence, etc., that holds the bicycle, frees the cable from the elements of the bicycle frame or/and wheels. if necessary, the user can disconnect the locking device from the holding structure from where it is mounted.

For convenience of storage, the cable is retracted back into the housing of the locking device by rotating the rotating cable drum and retracting the wire cable into the housing in a manner described above.

### BRIEF DESCRIPTION OF THE DRAWINGS

FIG. 1 is a general view of the anti-theft locking device of the invention, which as a whole is designated by reference numeral and is shown use for securing a bicycle to a stationary post.

FIG. 2 is a view of a wire cable suitable for use in the locking device of the invention.

FIG. 3 is a side sectional partially exploded view of a housing and a rotating cable drum, in which the rotating cable drum is shown in an assembled state but without the cable.

FIG. 4 is a top view on the device of the invention with one half of the housing removed.

FIGS. 5(a), (b), and (c) are schematic views similar to FIG. 4 that illustrate the principle of retracting of the cable onto the rotating cable drum of the locking device of the invention.

FIG. 6 is a side view that illustrates position of the wire cable wound on the rotating cable drum.

### DETAILED DESCRIPTION OF THE INVENTION

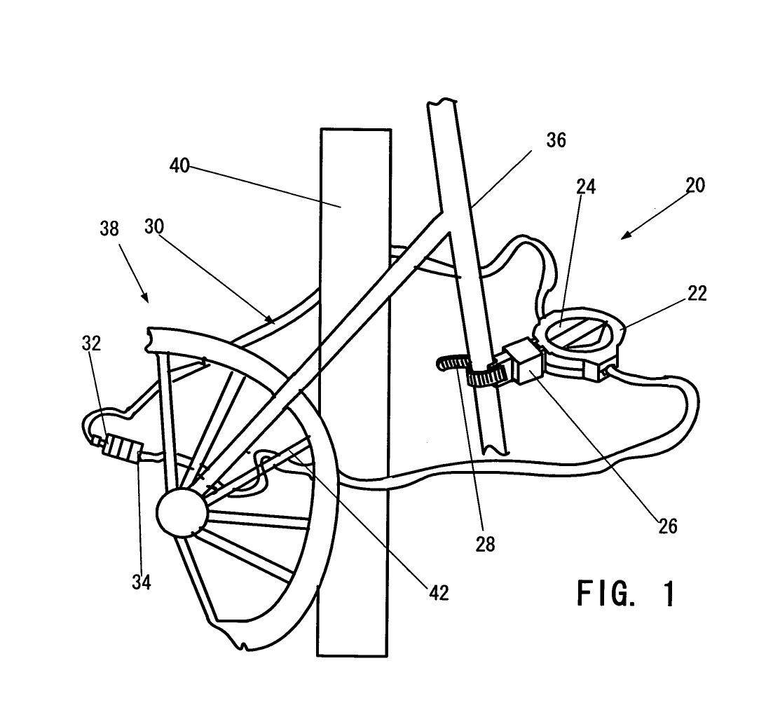

The anti-theft cable locking device of the invention is particularly suited for securing a bicycle but is not limited only to such application. A general view of the locking device of the invention, which as a whole is designated by reference numeral 20, is shown in FIG. 1 in use for securing a bicycle to a stationary post 40. The locking device 20 consists of a substantially cylindrical housing 22 that has a substantially cylindrical surface and contains a cable rotating drum 24, only the handle portion of which is shown in FIG. 1, a device holder 26 with a securing strap 28, and a wire cable 30 with locking elements 32 and 34 on the cable ends. In FIG. 1 the cable 30 is shown in the form of a loop wound around a frame section 36 of the bicycle 38, the stationary column 40 installed in the street, and is guided around the wheel spike 42. The housing serves not only for retracting the cable but also as a cable storage device.

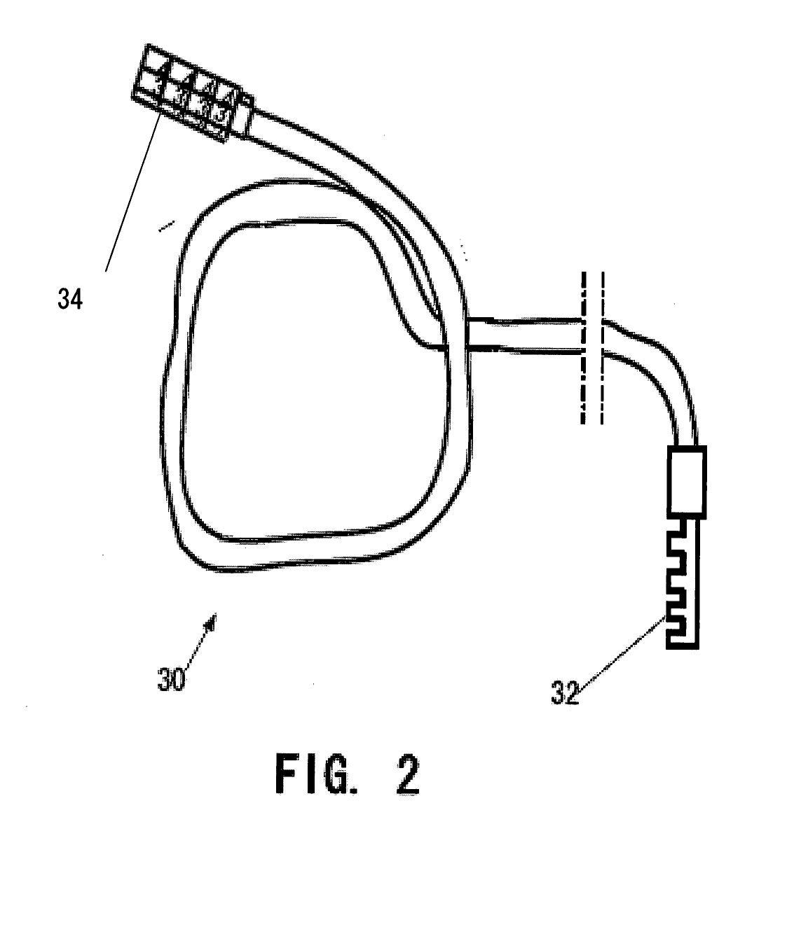

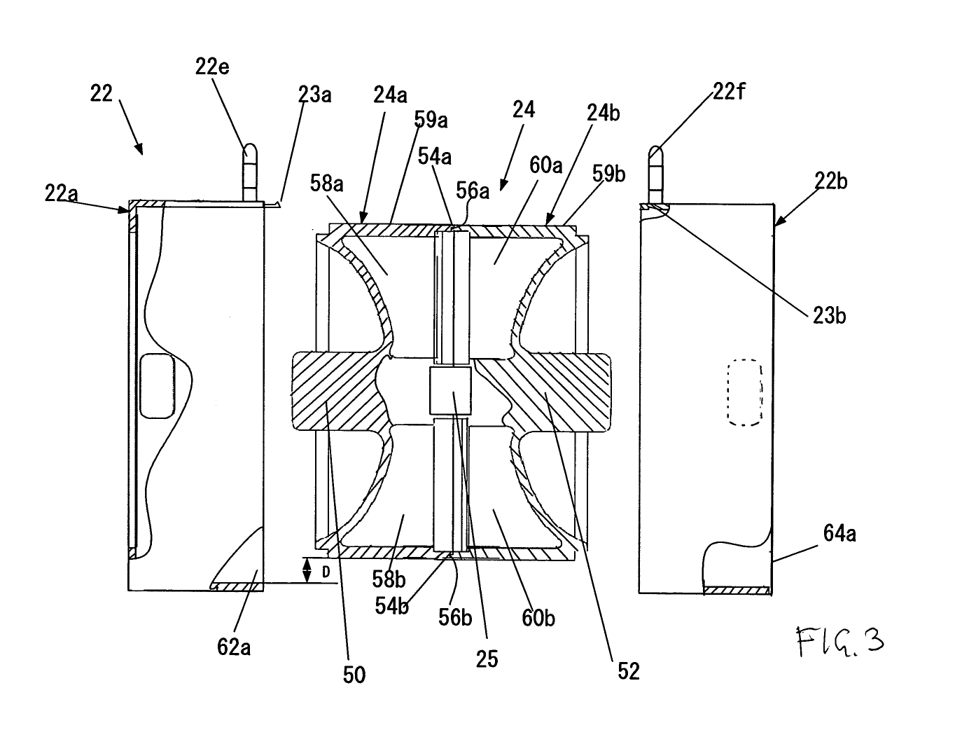

Let us now consider the main parts of the locking device 20 of the invention in more detail with reference to the attached drawings, where FIG. 2 is a view of a wire cable 30, and FIG. 3 is a side sectional partially exploded view in which the rotating cable drum 24 is shown in an assembled state but without the cable 30. This drawing also shows the cylindrical housing 22 (FIG. 1) that consists of two mutually opposite and symmetrical half-housings 22a and 22b.

In the illustrated embodiment (FIG. 3) the housing 22 is made from plastic, but it can be of other like material as the housing used to contain the semi-rigid cable and the drum. The housing is made in the form of two half-housing parts. One of the half-housings, e.g., a half-housing 22a, may have on its end face a male snapping projection 23a for engagement with a female recess 23b on the other half-housing 22b. This snapping connection is irreversible and when the device is assembled, the housing cannot be disassembled. The internal geometry of the housing 22 is intended to retain the cable 30 (FIG. 2) as it enters and is stored within.

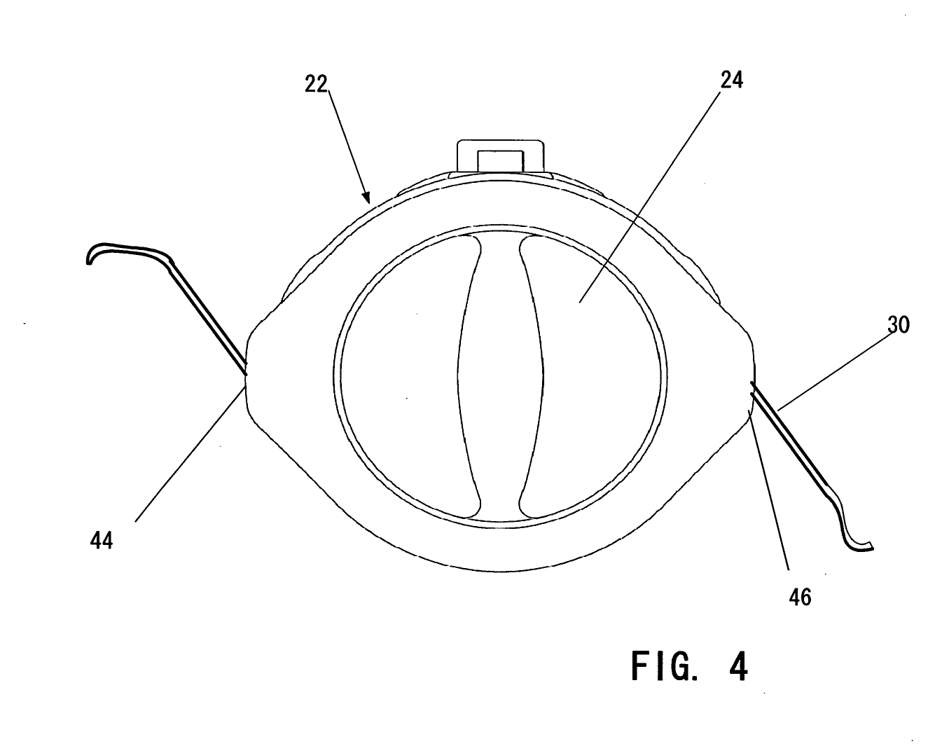

As can be seen from FIG. 4, which is a top view on the housing 22 with one half (22a) of the housing removed, in the assembled form the housing has two diametrically opposite openings 44 and 46, which have a tangential direction to the drum surface or are wide enough to provide tangential direction of the wire cable 30 at the entry/exit from the housing 22. The purpose of the directivity of these openings 44 and 46 is to guide and maintain the cable on the hubs within the housing during reeling in and pulling out.

The housing 22 has on its outer surface a radial outward protrusion that is formed by two protrusion elements 22e and 22f, as shown in FIG. 3. In the assembled state of the housing, these protrusions 22e and 22f are aligned and used for connection to the device holder 26 that is used as an adapter for connection of the anti-theft locking device 20 of the invention to the bicycle frame, as shown in FIG. 1. Currently the protrusions 22e and 22f are shown as male elements that can be connected to clips, straps, or other male/female features that will secure the housing assembly 20 to a bicycle or other object with the intention of securing it to this object.

The wire cable 30 is a continuous, semi-rigid straight wire cable or wire rope with inherent memory-like physical properties to maintain its shape. The length of the cable in the herein invention is 1.50 m to 2.0 m, but the length can be longer or shorter. In other words, the cable should be sufficiently long for forming a secure closed loop around elements of the bicycle and stationary structural items such as a post, fence, etc., and at the same time sufficiently short for holding the cable completely hidden in a wound state inside the housing 22. The diameter of the cable is relational to the space between the inner surface of the housing 22 and the outer surface of the rotating cable drum 24 onto which the cable 30 is retracted and should be smaller than the aforementioned space. In other words, the diameter of the cable 30 should not exceed dimension D shown in FIG. 3. An example of the cable wire cable used in the illustrated embodiment is a braided wire, nylon or alike, coated cable. The coating should provide a low coefficient of friction. As has been mentioned, in the herein invention, the cable 30 is not attached to the drum 24, but is threaded through the opening 25 (FIG. 3), which is slightly larger than the cable 30 diameter, formed in the assembled state of the drum between the hubs of the drum 24 which are described in details later.

The opposite ends of the wire cable 30 are provided with loops, or mutually engageable and interlocking elements, such as, e.g., an insertable deadbolt 32 and a dial-type cylinder that locks and releases the deadbolt only when a certain combination of numbers is aligned on the composite dial cylinder 34. An example of such a combination lock is disclosed in U.S. Pat. No. 5,899,099 (May 1999).

Let us now consider in more detail the aforementioned cable rotating drum 24, which is located inside the cylindrical housing 22 and is composed of a pair of the symmetric substantially cylindrical parts 24a and 24b having on their outer sides handles 50 and 52 for rotation of the drum in the direction of withdrawing the cable 30 into the interior of the cylindrical housing 22 while the other sides of the symmetric cylindrical parts 24a and 24b are connected and locked to each other in butt connection though engagement of projections 54a, 54b on one of the parts, e.g., the part 24a, with the recess 56a, 56b of the other part, i.e., the part 24b. The projections 54a, 54b and the recesses 56a, 58b are formed on pairs of diametrically arranged hubs 58a, 58b and 60a, 60b formed on the facing sides of the aforementioned symmetric cylindrical parts 24a and 24b. The hubs extends in directions parallel to the axis of rotation of the drum 24.

As has been mentioned above, the hubs 58a, 58b and 60a, 60b, which are monolithically molded with the rest of the bodies of the respective cable-driving drum parts, have a space 25 (FIG. 3) formed between the nearest points thereof. The outer surfaces 59a and 59b of the drum parts 24a and 24b have a siding fit in respective openings 62a and 64b formed in the end faces 62 and 64 of the housing parts 22a and 22b. Furthermore, the hubs 58a, 58b, 60a, 60b project beyond the mating end faces of the respective symmetric cylindrical parts 24a and 24b so that when the mating hubs 58 and 60 of the opposite cylindrical parts 24a and 24b are connected to each other through the interaction of the projections 54a, 54b and the recesses 56a, 58b, the aforementioned space 25 is formed. This space 25 and the aforementioned distance D between the outer diameter of the drum 24 and the inner surface of the housing parts 22a and 22b are sufficient for guiding the wire cable 30 through the locking device 20 and for storing thereof in the locking device 20.

During assembly, the two cylindrical parts 24a and 24b of the rotating cable drum are assembled with each other by inserting the projections 54a and 56a on the end faces of the hubs 58 and 60 into respective recesses 54b and 56b on the facing end faces of the hubs. During assembling of the cylindrical parts of the rotating cable drum 24 the central part of the wire cable 30, which in this case is straighten out, is placed into the opening formed between the hubs 58 and 60 and is loosely sandwiched between them. In an assembled state with the wire cable 30 between the cylindrical parts 24a and 24b of the drum 24, these parts are nested in the respective symmetrical cylindrical parts 22a and 22b of the cylindrical housing 22 which are snapped together though the engagement of the projection 22c with the recess 22d (FIG. 3) so that the drum 22 with the wire cable 30 remains intact, the handle portions 50 and 52 of the drum are exposed on both sides of the cylindrical housing, and the rotating cable drum 24 can freely rotate inside the cylindrical housing 22, while both ends of the wire cable 30 extend outward from the assembled device and can be used for its purpose (FIG. 1).

Thus, the semi-rigid wire cable is retracted by the outer surface of the drum 24 in the space (having the radial size D (FIG. 3)) between the inner diameter of the housing 22 and the outer diameter of the drum 24 by continually rotating the rotating cable drum 24 in a consistent clockwise or counter-clock direction, depending on from what side of the cable locking device the user prefers.

As has been mentioned above, the cable 30 does not wind onto the drum 24. Therefore, rotation of the drum 30 opposite the retracted direction will not extend the cable 30 out from the locking device 20. The cable sections can be pulled out from the locking device 20 only by applying the pulling equal manually force to both cable ends in the outward direction from the device housing 22. However, the projecting ends of the cable 30 can be retracted back into the housing 22 of the device 20 by rotating the rotating cable drum handles 50 and 52 in the continuous desired direction.

A mounting device 26 (FIG. 1) comprises an adapter one side of which is connectable to the radial outward projection. This projection is formed by projection parts 22e and 22f (FIG. 3) which are molded integrally with the housing. The other side has of the adapter 26 has a strap 28 for securing to the element of the bicycle frame, e.g., the saddle post 36 (FIG. 1). The adapter 26 may have an option to rotate that enables the user more flexibility and ease of use to pull and reel the cable. The molded strap may comprise a molded article and can be made of a plastic material or cloth such as nylon or hook and loop material. The strap 28 can also be a separate piece from the adapter 26. An example of a mounting device suitable for the invention is the device disclosed in US Patent Application Publication No. 20006/0124679 (inventor: J. Chen).

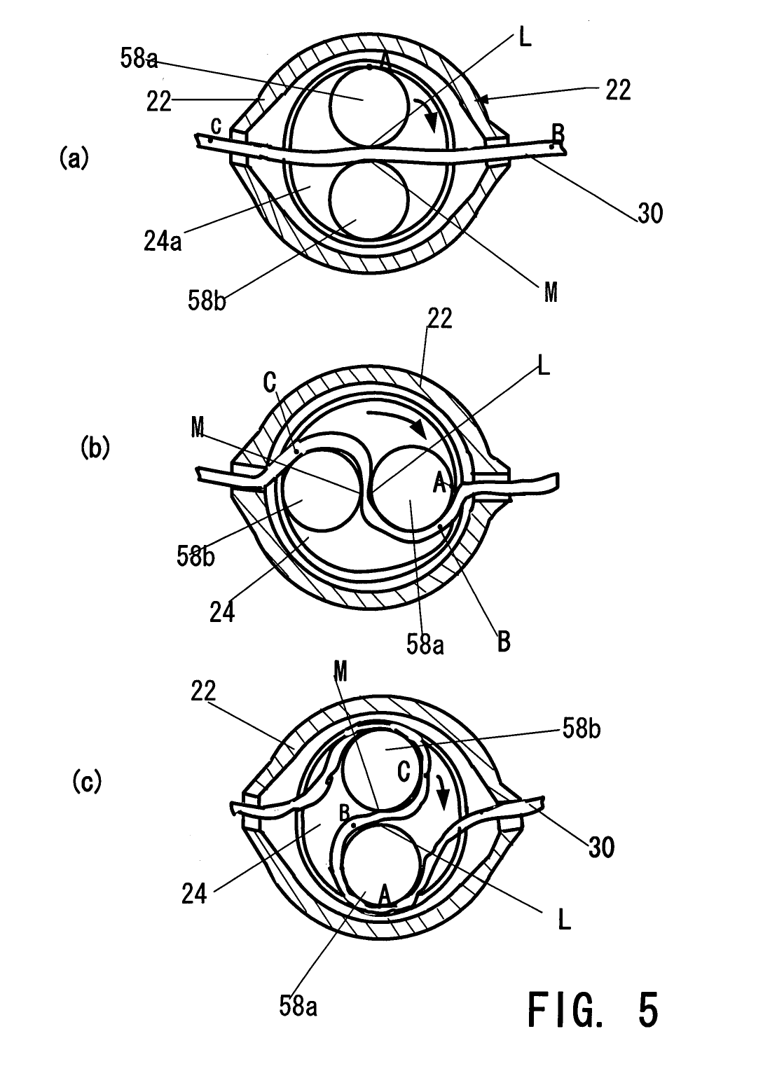

The mechanism of retracting and directing of the cable 30 inside the device 20 will now be described with reference to FIGS. 5(a), (b), and (c).

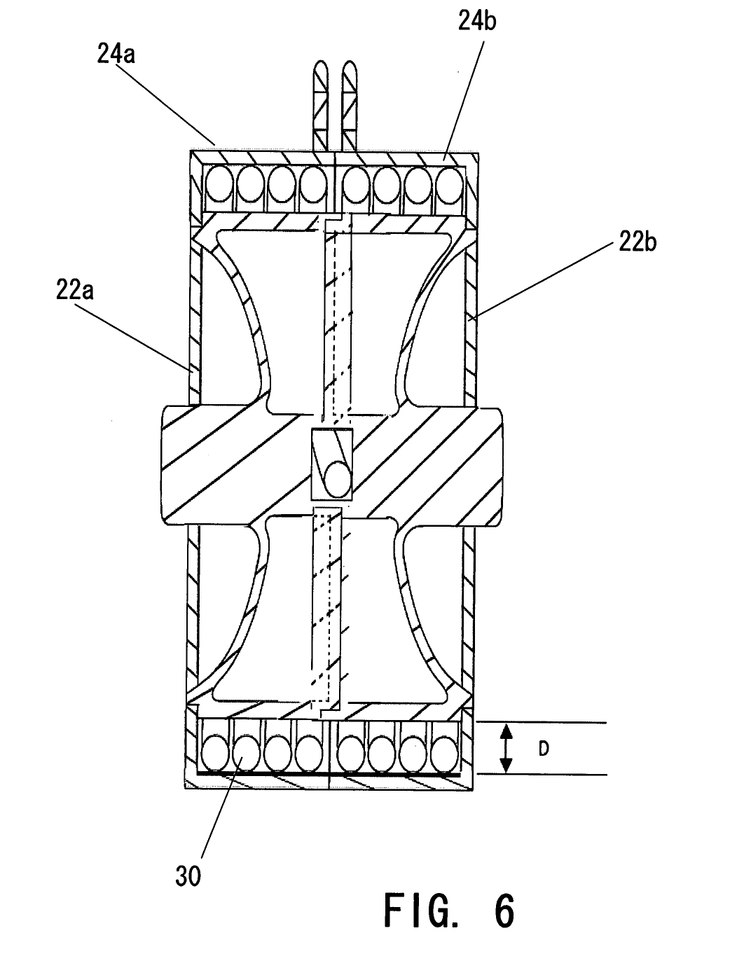

More specifically, when the drum 24 is rotated with the cable 30 passing through the openings 44 and 46 (FIG. 4) of the drum 24 and the housing 22 and between the points L and M of the hubs (FIG. 5) nearest to each other, e.g., in the form of a straight line, the cranking action of the hubs deforms the cable 30 first in the form of letter “S” (for a viewer from the handle side of the drum) and then continues retracting of the cable in the form of a plurality of “S”-shaped turns arranged side by side parallel to each other within the housing by being guided by the inner surface of the housing 22 and the diametrically opposed openings 44 and 46 in the housing 22 while contained by the interior surface of the housing. More specifically, FIG. 5(a), 5(b), and 5(c) show sequential positions of points A, B, and C on the cable 30 during one revolution of the drum 24 in the direction of withdrawal of the cable into the housing 22. FIG. 5(a) shows positions of points A, B, and C on the cable 30 when the cable 30 is straightened. FIG. 5(b) shows positions of points A, B, and C after the drum 24 was turned by 90° in the clockwise direction. FIG. 5(c) shows positions of the points A, B, and C after the drum 24 was turned in the clockwise direction by 180° from the positions of FIG. 5(a). It can be seen that turning of the drum by 180° guides the cable 30 and retracts it onto the hubs 58a, 58b and 60a, 60b in the form of letter S. Continuing rotation of the drum will form cable turns arranged side by side on the drum in a manner shown in FIG. 6, i.e., so that one extended portion 30a of the cable 30 is guided and laid onto the part 24a of the drum 24 which functions as a first cable retracting part while the other extended portion 30b of the drum 24 is laid onto the part 24b of the drum 24 and functions as a second cable retracting part.

The space defined by dimension D (FIG. 3) between the rotating cable drum 24 and interior housing surface prevents the cable 30 from retracting on a prior turn(s), and moves the prior turns to the center of the rotating cable drum to allow the cable 30 to continue to manually be retracted into the housing 22.

In use, the ends of the cable 30 are fashioned into loops or other configurations which are of a size to maintain it outside of the housing 22 (FIG. 1). The cable 30 is manually withdrawn to its desired length so as to completely run through the frame of the bicycle 38, both wheels, around a stationary object 40, or the like, and the ends of the cable are locked together by means of the locking elements 32 and 34 on the opposite ends of the wire cable 30. The cable 30 is then retracted into the housing 22 by rotating one or both of the externally exposed handles, e.g., the handle 50 of the rotating drum, for adjusting the length of the exposed length of the wire cable.

For disconnection of the locking device from the bicycle, the user unlocked the lock that holds the ends 32 and 34 of the wire cable 30, releases the cable 30 from the stationary element, such as a post 40 that holds the bicycle, frees the cable 30 from the elements of the bicycle frame or/and wheels, and, if necessary, disconnects the holding structure 26 from the bicycle frame.

For convenience of storage, the cable 30 is retracted back into the housing 22 of the locking device 20 by rotating the rotating cable drum 24 (FIGS. 5A, b, and c) and retracting the wire cable 30 into the housing 22 in a manner described above.

Thus it has been shown that the bicycle anti-theft cable locking device of the invention is simple in construction, easy to manufacture, involves a minimum of different parts, is composed of durable easily, inexpensively manufactured molded plastic parts, can be easily operated by a left- and right-handed person, is provided with a cable storage unit for storing the unused portion of the cable during the use or for storing the entire cable during storage of the device, eliminates the dangerous tension and auto-retractable operation and internal part complexity revealed in the prior art, and can be secured without damage to the bicycle or injure to the user.

While the invention has been described with reference to specific embodiments, the description is illustrative of the invention and is not to be considered as limiting the invention. Various modifications and applications may occur to those skilled in the art without departing from the true spirit and scope of the invention. For example, The housing parts can be connected by means different from irreversible snapping connection, e.g., they can be connected by screws, or permanently welded together by thermal welding, bonding by means of an adhesive agent, etc. Alternatively, the cable can be situated so that it is fixed at the midpoint of the continuous cable between hubs to prevent sliding. The cable ends can be secured and locked by means other than the interlocking elements shown in the drawings. The mounting system can also have the option of being permanently fixed to the desired location, and not have the ability to rotate or insert and release from the mount.

1. An anti-theft locking device with a flexible cable comprising:
a substantially cylindrical housing having a substantially cylindrical surface and two diametrically opposite openings on the aforementioned cylindrical surface;
a drum rotatingly supported in the aforementioned housing, having and outer surface, an axis of rotation, and a handle portion exposed though the cylindrical housing for manual rotation of the drum; and
a flexible cable that has a diameter and a length and freely passes through the cylindrical housing and through the drum and exits from the housing through the aforementioned two diametrical openings forming a first portion of the flexible cable that extends through one of the diametrical openings and a second portion of the flexible cable that extends through the other diametrical opening;
the drum having a cranking device that during rotation of the drum retracts said cable into the housing in the form of S-shaped turns.

2. The anti-theft locking device of claim 1, wherein the cranking device comprises two hubs formed in the middle of the drum in the direction parallel to the direction of rotation of the drum, the nearest points of the hubs being spaced from each other and form an drum opening that is greater than the diameter of the cable, the cylindrical housing having an inner surface, and the distance between the inner surface of the housing and the outer surface of the drum is greater than the diameter of the cable.

3. The anti-theft locking device of claim 2, wherein the aforementioned hubs divide the drum into a first cable retracting part and a second cable retracting part so that during rotation of the drum the aforementioned first portion of the flexible cable is wound by said cranking device in the form of S-shaped turns on the first cable retracting part and the aforementioned second portion of the flexible cable is retracted by said cranking device in the form of S-shaped turns on the second cable retracting part.

4. The anti-theft locking device of claim 1, wherein the cylindrical housing consists of two symmetrical parts connected to each other face to face and having mutually locking elements that holds both symmetrical parts together.

5. The anti-theft locking device of claim 4, wherein the locking elements comprise an irreversible snapping latch.

6. The anti-theft locking device of claim 2, wherein the cylindrical housing consists of two symmetrical parts connected to each other face to face and having mutually locking elements that holds both symmetrical parts together

7. The anti-theft locking device of claim 6, wherein the drum consists of two symmetrical drum halves which are connected face to face and form in the assembled state the aforementioned drum opening, the drum has a width and a cable guiding recess on the outer surface of the drum for guiding the first S-shaped turn of the flexible cable, the furthest points of the cylindrical portions of the cranking device being substantially in flush with the outer surface of the drum.

8. The anti-theft locking device of claim 7, wherein the flexible cable is a semi-rigid wire cable.

9. The anti-theft locking device of claim 1, which is a bicycle anti-theft locking device wherein the cylindrical housing has a member for attaching the anti-theft locking device to a bicycle.

10. The anti-theft locking device of claim 5, which is a bicycle anti-theft locking device wherein the cylindrical housing has a member for attaching the anti-theft locking device to a bicycle.

11. The anti-theft locking device of claim 7, which is a bicycle anti-theft locking device wherein the cylindrical housing has a member for attaching the anti-theft locking device to a bicycle.

12. The anti-theft locking device of claim 5, wherein the cranking device comprises two cylindrical portions formed in the middle of the drum in the direction parallel to the direction of rotation of the drum, the nearest points of the hubs being spaced from each other and form an drum opening that is greater than the diameter of the cable, the cylindrical housing having an inner surface, and the distance between the inner surface of the housing and the outer surface of the housing is equal to or greater than the diameter of the cable.

13. The anti-theft locking device of claim 12, wherein the aforementioned hubs divide the drum into a first cable retracting part and a second cable retracting part so that during rotation of the drum the aforementioned first portion of the flexible cable is retracted by said cranking device in the form of S-shaped turns on the first cable retracting part and the aforementioned second portion of the flexible cable is retracted by said cranking device in the form of S-shaped turns on the second cable retracting part.

14. The anti-theft locking device of claim 10, wherein the cranking device comprises two cylindrical portions formed in the middle of the drum in the direction parallel to the direction of rotation of the drum, the nearest points of the hubs being spaced from each other and form an drum opening that is greater than the diameter of the cable, the cylindrical housing having an inner surface, and the distance between the inner surface of the housing and the outer surface of the housing is equal to or greater than the diameter of the cable.

15. The anti-theft locking device of claim 14, wherein the aforementioned hubs divide the drum into a first cable retracting part and a second cable retracting part so that during rotation of the drum the aforementioned first portion of the flexible cable is retracted by said cranking device in the form of S-shaped turns on the first cable retracting part and the aforementioned second portion of the flexible cable is retracted by said cranking device in the form of S-shaped turns on the second cable retracting part.

16. The anti-theft locking device of claim 3, which is a bicycle anti-theft locking device wherein the cylindrical housing has a member for attaching the anti-theft locking device to a bicycle.

17. The anti-theft locking device of claim 10, wherein the cylindrical housing consists of two symmetrical parts connected to each other face to face and having mutually locking elements that holds both symmetrical parts together.

18. The anti-theft locking device of claim 17, wherein the locking elements comprise an irreversible snapping latch.
